(19) United States
(12) Patent Application Publication
(10) Pub. No.: US 2006/0273544 A1
(43) Pub. Date: Dec. 7, 2006

(54) Attachment for a bicycle

(76) Inventor: Matthew Donovan, Toronto (CA)

Correspondence Address: MILLER THOMPSON, LLP, Scotia Plaza, 40 King Street West, Suite 5800, TORONTO, ON, M5H 3S1, CA

(21) Appl. No.: 11/446,503

(22) Filed: Jun. 5, 2006

Related U.S. Application Data
(60) Provisional application No. 60/686,955, filed on Jun. 3, 2005.

(51) Int. Cl. B62K 7/00

(52) U.S. Cl. 280/282

(57) ABSTRACT

An attachment for a bicycle comprising a universal joint presenting an axis securable to the forks of a bicycle; said universal joint including a stationary bar and a displaceable bar, said displaceable bar disposed substantially parallel to said stationary bar; the ends of said stationary and displaceable bars including means for attaching wheels.

### FIELD OF INVENTION

This invention relates to an attachment for converting a bicycle into a tricycle and more particularly into a reverse tricycle where there are two wheels in front that steer the vehicle. The invention also relates to the method of converting a bicycle into a tricycle.

### BACKGROUND OF THE INVENTION

Various devices and methods have heretofore been designed in order to attempt to smoothly transition a child from a tricycle to a bicycle.

Such devices include training wheels which are attachable to the back wheels of a bicycle so as to permit stability to a young user of a bicycle.

Furthermore, U.S. Pat. No. 6,164,666 relates to a child's cycle which is adaptable as the child grows between a tricycle configuration and a bicycle configuration.

Furthermore it is known to add on front wheel casters for jogging strollers as disclosed in U.S. Pat. No. 6,449,801.

It is an object of this invention to provide an improved attachment and method of attaching a device for converting a bicycle into a tricycle.

It is a further object of this invention whereby the attachment does not alter the original bicycle so as to permit removal of the attachment and turn the tricycle back into a bicycle.

Furthermore it is an object of this invention to provide an attachment that can be adjusted to fit different sizes of bicycles.

These and other objects and features of the invention shall now be described in relation to the following drawings.

### BRIEF DESCRIPTION OF DRAWINGS

FIGS. 1a and 1b are photographs which illustrate the attachment attached to a bicycle which has been converted to a tricycle.

FIGS. 2a and 2b are other photographs illustrating the attachment.

FIG. 3 is a partial perspective view of the attachment secured to the frame of a bicycle.

FIG. 4 is a front elevational view of the attachment.

FIG. 5 is a top plan view of the attachment.

FIG. 6 is perspective partial view of the universal joint.

FIG. 7 is a perspective view of another embodiment of the invention.

FIG. 8 is a top plan view of FIG. 7.

### BEST MODE FOR CARRYING OUT THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

The figures generally illustrate an attachment 2 secured to the bicycle frame 4.

In particular the bicycle frame 4 comprises a head tube 6, top tube 8, seat tube 10, seat stays 12, chain stays 14, bottom bracket 16, down tube 18, and forks 20.

The attachment 2 is comprised of a four bar linkage that is fixed to the bicycle at three points, namely.

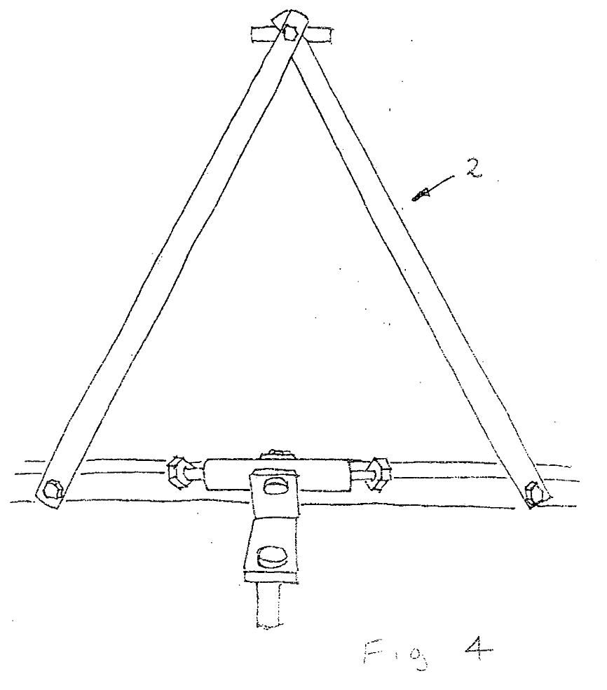

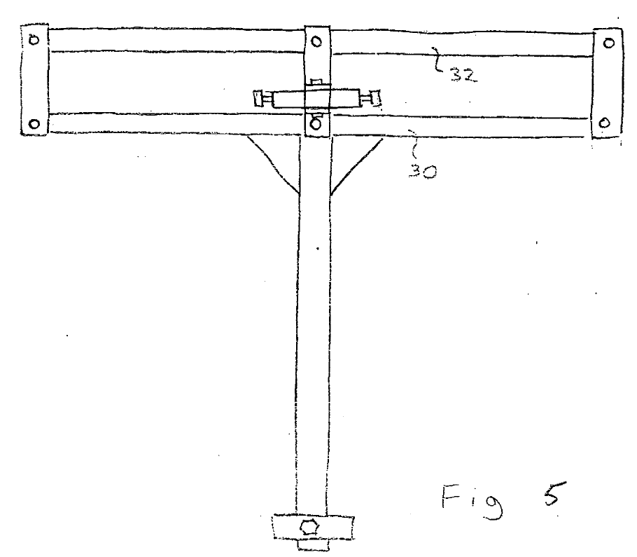

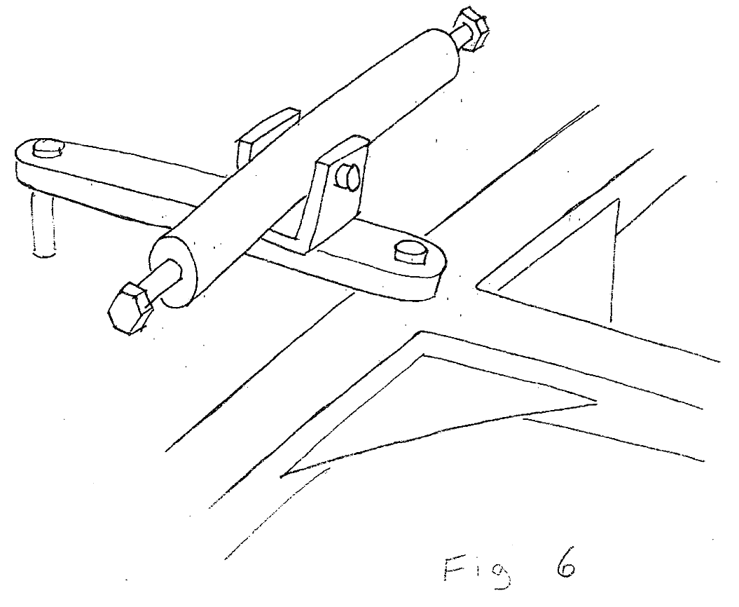

1. the attachment 2 is fixed to the chain stay 14 directly behind the bottom bracket 16 with a bar welded perpendicular to one of the linkage bars. The length of the bar 22 is adjustable to adapt to different size bicycles. In the embodiment shown in FIG. 3 the bar 22 is cut to size. Alternatively, the bar 22 may comprise of a telescoping assembly having springs (not shown) between the two telescoping member to adapt to different sizes. The clamp 24 is a bolt that passes through the chain stays 14 just behind the bottom bracket threading into a block that runs perpendicular to the chain stays (similar to a kickstand).

2. The attachment 2 is also fixed to the head tube 6 by means of two stabilizers that stabilized the bicycle and fix it into an upright position. The length of the stabilizers 26 are also adjustable to adapt to different size bicycles. The clamp 28 on the head tube 6 is adjustable to adapt the different size bicycles and in particular to different diameters of head tube 6. The clamp 28 on the head tube 6 is a tube or pipe clamp with bolts for attaching the stabilizers 26. The stabilizers 26 are bolted to the same linkage bar 30 that is fixed to the bottom bracket 16.

3. The attachment 2 is bolted to the dropouts on the front fork 20 through a modified universal joint 40. The attachment 2 takes the place of the front wheel in the bolts.

In other words the front wheel of a bicycle is removed and that attachment 2 is secured to the bicycle frame 4 to convert the bicycle into a tricycle.

Other arrangements of stabilizers 26 may be utilized such as cables or the like.

Linkage

The attachment includes a four bar linkage system that has two long bars 30 and 32 that run perpendicular to the length of the bicycle and the axis of rotation necessary for steering the bicycle.

The first of these bars 30 is fixed to the bicycle and does not move. The second bar 32 remains parallel to the first but moves relative to the first bar 30 from side to side to transfer movement to the other parts of the linkage.

Furthermore the attachment also includes short bars, namely, 34 and 36. Short bars 34 and 26 are disposed on either of the long bars 30 and 32 so as to complete the four bar linkage. Furthermore a third short bar 38 is disposed between the short bars 34 and 36 for transferring movement from the bicycle to the linkage.

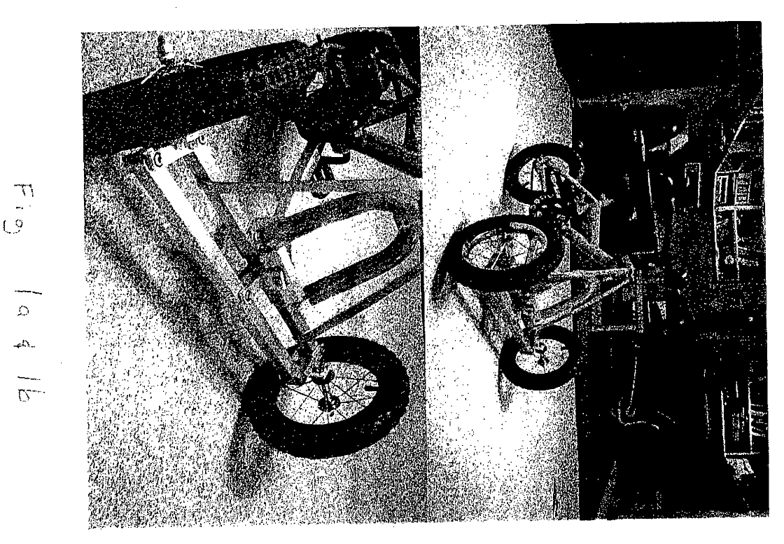

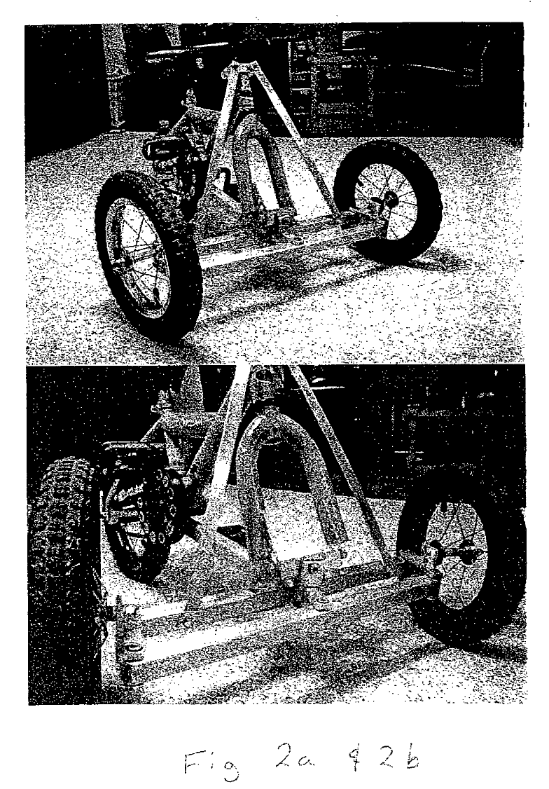

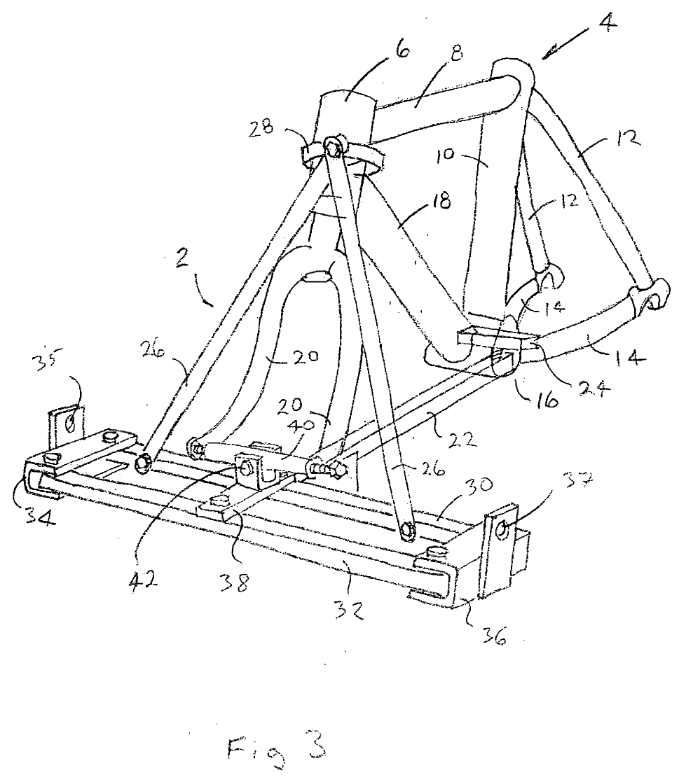

There are two front wheels bolted to the short bars 34 and 36 on either end of the long linkages 30 and 32 as disclosed in FIGS. 1a-b.

All of the short bars 34, 36, and 38 are substantially parallel to the length of the bicycle and perpendicular to the axis of rotation necessary for steering the bicycle.

The axis of the pivot that connect the ends of the linkage bars together run perpendicular to the linkage bars and approximately parallel to the axis of rotation necessary for steering the bicycle.

### DESCRIPTION OF THE MODIFIED UNIVERSAL JOINT

The universal joint 40 connects to the bicycle fork 20 with an axle that is similar to the axle of a wheel (not shown). The universal joint 40 includes a joint 42 that is disposed in the center and perpendicular to the axle. The axis of the pivot 42 is approximately parallel to the length of the bicycle and perpendicular to the axis of rotation necessary for steering the bicycle. The pivot 42 is connected to the short bar 28 in the center of the linkage. The pivot 42 is mounted forward of the pivot that connects the middle short bar 38 to the stationary long bar 30 of the linkage.

The mounting of the pivot 42 on the bar 38 is adjustable along the length of the bar in order to adjust to the different sizes of various bicycle forks. It is the movement of the pivot 42 connecting the middle short bar 38 to the long stationary bar 30 that defines the universal joint.

The axis of the pivot 42 is offset by the same distance that the axis of the forks 20 of the front wheel are in the head tube 6, and the rotation necessary for steering the bicycle are offset in the normal functioning of a bicycle.

The specific relationship between the two pivots of the modified universal joint and the device can simulate the movement of a front wheel on a bicycle and transfer that movement through a four bar linkage to the two front wheels.

### OTHER EMBODIMENTS

Other embodiments include arrangements where the two stabilizers 26 that stabilize the bicycle could be mounted to the short linkages where the wheels are attached. In this situation, as the wheels are being turned the bicycle would:

1. tilt into the radius of the turn;

2. shift the center of the bicycle's gravity to the inside of the turn;

3. therefore make the tricycle more stable.

Furthermore by adjusting the bolting on the stabilizers along the length of the short bar 34 and 36 the linkage will also adjust the amount of tilt when cornering.

Furthermore the short bars 34 and 36 include apertures 35 and 37 which are adapted to receive bolts that present axis of rotation for the two wheels as shown in the photographs in FIGS. 1a-b.

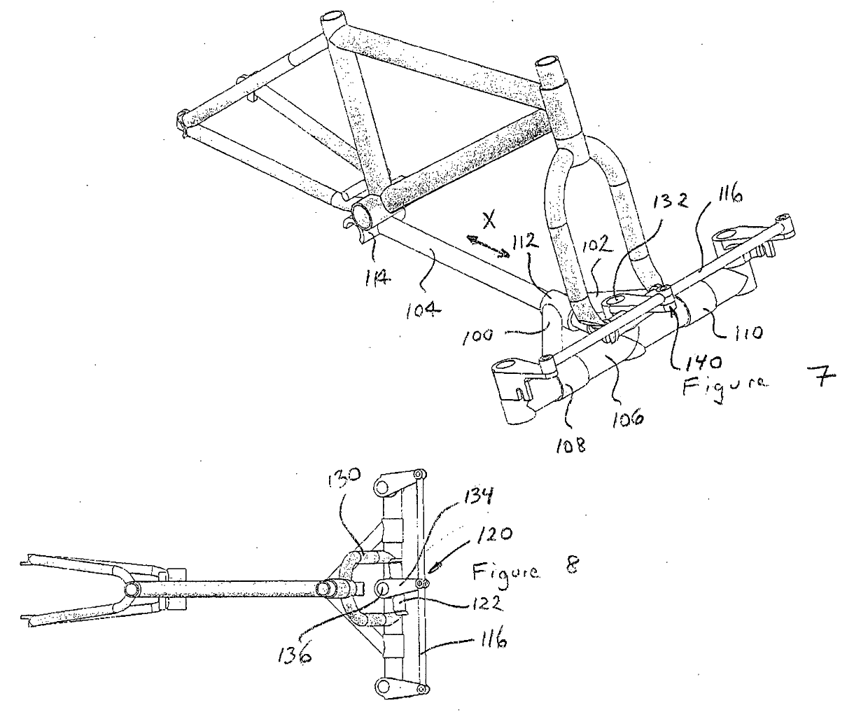

FIG. 7 illustrates a further embodiment of the invention which includes angled bars 100 and 102 secured to a longitudinal bar 104.

Furthermore the embodiment shown in FIG. 7 includes a first transverse bar 106 which includes connections 108 and 110 which adjust to ensure the linkage pivots are parallel with the axis of rotation of the bicycle fork.

Moreover angled bars 100 and 102 are secured to a displaceable connection 112 which is displaceable axially along bar 104 in the direction shown in FIG. 7 marked by the letter “X” to adjust the different sizes of bicycles.

Moreover the other end of the bar 104 includes a clamping arrangement 114 so as to clamp the bar 104 to one end of the bicycle as shown.

Furthermore a second transverse bar 116 is utilized which connects between its ends to linkage means 120 which comprises a connecting bar 122 which includes at its opposite ends an external thread that is accommodated by the front fork 130 of a bicycle. The connecting bar 122 includes an upstanding post 132 which is generally fixed and adapted to be received by a pivot bar 134. The pivot bar includes at one end a hole 136 which receives the upstanding post 132 and at the other end thereof a clamping device 140 which clamps the moveable transverse bar 116.

Furthermore pivots A, B, C, D form a trapezoid shape instead of a parallelogram so as to enable the wheels which will be attached thereto to track around corners in an improved fashion.

Furthermore the embodiments shown in FIGS. 7 and 8 illustrate the removal of the universal joint as previously described as an alternative.

The universal joint could be used for a version the bicycle where the bike leans into the corners.

Various embodiments of the invention have now been described in detail. Since changes in and/or addition to the above-described best mode may be made without departing from the nature, spirit or scope of the invention, the invention is not to be limited to said details.

I claim:

1. An attachment for a bicycle comprising:
(a) a universal joint presenting an axis securable to the forks of a bicycle;
(b) said universal joint including a stationary bar and a displaceable bar, said displaceable bar disposed substantially parallel to said stationary bar;
(c) the ends of said stationary and displaceable bars including means for attaching wheels.

2. An attachment for a bicycle comprising:
(a) first bar means disposed generally in line with said bicycle and;
(b) transverse bar means disposed generally transverse to said first bar means and said transverse bar means including two spaced wheels
(c) stabilizing means having one end for removable attachment to said front of said bicycle and another end pivotally connected to said transverse means.

3. An attachment as claimed in claim 1 wherein said transverse bar means includes a first transverse bar and a second spaced transverse bar.

4. An attachment as claimed in claim 2 wherein said first and second transverse bars include a universal device.

5. A method of converting a bicycle into a tricycle comprising:
(a) removing the front wheel of said bicycle;
(b) securing an attachment to the front forks of the bicycle;
(c) attaching two spaced wheels to the attachment.
